(19) United States
(12) Patent Application Publication
(10) Pub. No.: US 2023/0409979 A1
(43) Pub. Date: Dec. 21, 2023

(54) MACHINE LEARNING-BASED GRAPH ANALYTICS FOR USER EVALUATION

(71) Applicant: RIBBIT Inc., Oxford, OH (US)

(72) Inventors: Steven Michael Thompson, Highlands Ranch, CO (US); Eric Alan VonDohlen, Gilbert, AZ (US)

(21) Appl. No.: 18/321,373

(22) Filed: May 22, 2023

Related U.S. Application Data
(60) Provisional application No. 63/365,095, filed on May 20, 2022.

(51) Int. Cl. G06N 20/00

(52) U.S. Cl. CPC G06N 20/00

(57) ABSTRACT

Aspects of the present disclosure relate to machine learning-based graph analytics for account evaluation. In examples, information associated with a user is stored in a graph datastore, which may include one or more account nodes and associated transaction nodes. Nodes within the graph datastore may be associated using edges that include identification information for an associated user. Accordingly, it may be possible to identify a subpart of the graph associated with a user that includes associated user identifiers and historical activity, which may be processed to generate a feature vector. The feature vector may be processed using a machine learning model to generate a set of reputation metrics for the user. The resulting set of reputation metrics may thus be used to determine whether to permit access to a resource or service by the user, or whether the user is permitted to create a new account, among other examples.

### CROSS-REFERENCE TO RELATED APPLICATION

This application claims priority to U.S. Provisional Application No. 63/365,095, titled “Machine Learning-Based Graph Analytics for User Evaluation,” filed on May 20, 2022, the entire disclosure of which is hereby incorporated by reference in its entirety.

### BACKGROUND

A user and/or an associated user identifier may be evaluated to determine whether to permit access to a resource and/or a service, among other examples. However, the user may be reluctant to provide or may not provide certain information (for example, information that may decrease the likelihood of a positive determination). As another example, additional information that would be relevant to such a determination may be difficult to independently obtain. As a result, such determinations may be made using limited information and may thus provide limited insight into the actual reputation of the user.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to machine learning-based graph analytics for user evaluation. In examples, information associated with a user is stored in a graph datastore, which may include one or more user identifier nodes and associated transaction nodes. Nodes within the graph datastore may be associated using edges that include identification information for an associated user. Accordingly, it may be possible to identify a subpart of the graph for a given user that includes associated user identifiers and historical activity, which may be processed to generate a feature vector. The feature vector may be processed using a machine learning model to generate a set of reputation metrics for the user. The resulting set of reputation metrics may thus be used to determine whether to permit access to a resource or service by the user, or whether the user is permitted to create a new user identifier, among other examples.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for machine learning-based graph analytics for user evaluation.

FIGS. 2A and 2B illustrate overviews of example graphs with which aspects of the present disclosure may be performed.

FIG. 3 illustrates an overview of an example method for maintaining a graph datastore according to aspects of the present disclosure.

FIG. 4 illustrates an overview of an example method for training a machine learning model for user evaluation.

FIG. 5A illustrates an overview of an example method for processing a reputation request by a verification platform.

FIG. 5B illustrates an overview of an example method for evaluating a user identifier according to a set of reputation metrics obtained from a verification platform.

FIG. 6 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user's reputation may be used to determine whether to permit access to a resource and/or service by the user. As an example, the reputation may be indicative of a user's payment affordability risk and/or may be used to identify fraud. However, if the user provides information with which the user's reputation is generated, the user may have an incentive to provide information that presents the user positively. As a result, information that is likely to have a negative effect on the user's reputation is unlikely to be provided by the user and may thus be difficult to obtain and evaluate when generating a reputation for the user. This may result in instances where a reputation that is generated for a user does not accurately represent the actual reputation of the user, such that the stability and/or level of risk for the user may be artificially positive or otherwise inaccurate, among other detriments.

Accordingly, aspects of the present disclosure relate to machine learning-based graph analytics for user evaluation. In examples, information associated with a user is stored in a graph datastore, which may be updated when a user identifier is created or used (e.g., for a transaction), among other examples. A subset of nodes and edges within the graph datastore (also referred to herein as a “graph subpart”) may be identified based on a unique identifier associated with the user identifier (e.g., a globally unique identifier (GUID) or an account number) and/or using identification information for a user (e.g., a first name, a middle name, a last name, an email address, a phone number, and/or a mailing address, device ID, IP address, among other personally identifiable information). The graph subpart is processed to generate a feature vector that is processed using a machine learning model. As an example, the machine learning model may have been trained based on a training graph datastore including user identifiers and/or associated historical activity indicative of a “good” or “acceptable” reputation, as well as user identifiers and/or associated historical activity that are not indicative of a good or acceptable reputation.

Thus, feature vectors for acceptable graph subparts and for unacceptable graph subparts may be generated from the training graph datastore and labeled accordingly. As a result of processing the graph subpart using the trained machine learning model, a model processing result may be generated that includes one or more reputation metrics, as is discussed in greater detail below. Example reputation metrics include, but are not limited to, a stability metric indicating an estimated relative payment stability (e.g., on a scale from 1-10 or 1-100, associated with a user's historical activity) or a supplemental information metric may be generated that indicates a likelihood that a user would provide access to additional data (e.g., by logging into a third party service) that may be used to perform additional processing with respect to a user's reputation.

As an example, a graph datastore may include a node for a user identifier associated with the user and/or a node for a transaction associated with the user identifier. Nodes may have one or more associated properties, including, but not limited to, account information (e.g., an account number, an account balance, a first seen date, a last used date, and/or a date of last returned payment) or transaction information (e.g., a transaction date, a transaction amount, an indication of a transaction sender and/or recipient (e.g., an account or associated identification information), and/or an indication as to whether the transaction was successful, unsuccessful, failed due to account closure, or indicated fraud, among other examples).

As used herein, a user identifier may include an account of an online service (e.g., a social media platform), a cryptographic wallet (e.g., comprising one or more cryptographic keys and associated addresses), or an account associated with a financial institution (e.g., a bank account, a credit union, or a card issuer), among other examples. For example, identification information of the user identifier may comprise a debit or credit card number, or a bank account number. In examples, a user identifier is associated with a device and/or one or more requests associated with the device. Example devices include, but are not limited to, computing devices (e.g., a mobile computing device, a tablet computing device, a laptop computing device, or a desktop computing device) or smart payment devices (e.g., a card including a magnetic strip or an integrated circuit that stores associated identification information).

A user identifier node may be uniquely identifiable based on a combination of an account identifier and/or associated user identification information. For example, a combination of an account number and a last name may be used, such that the same account node may be used in instances where a family shares the same account.

In examples, a transaction node may be added or updated within the graph datastore prior to the existence of a user identifier node, such that a corresponding user identifier node may be created as a result of identifying a transaction associated with a user identifier for which a user identifier node has not yet been created. Nodes within the graph datastore (e.g., a user identifier node and a transaction node, a first user identifier node and a second user identifier node, or any other such combinations) may be associated using one or more edges, where an edge includes identity information for the user.

As a result, an account node may function as a central node, with which a graph subpart further comprising associated transaction nodes and edges (including identification information of a user for which the transaction was performed) may be identified. Thus, as compared to instances where a user functions as a central node and accounts/historical activity are associated with such a central user node, the disclosed aspects may enable the identification of additional user identifiers and/or other relationships (e.g., multiple users using or otherwise associated with a single user identifier) that would otherwise be difficult and/or time-consuming to identify.

Information used to update or query the graph datastore may be preprocessed so as to improve the likelihood that nodes associated with the same user and/or user identifier are correctly associated within the graph datastore (as compared to forming two or more unrelated graph subparts for the same user or user identifier). Restated, preprocessing identification information and/or transaction information may improve the reliability with which existing nodes and edges are matched or otherwise identified accordingly. Thus, various techniques may be used for preprocessing such data and it will be appreciated that aspects described herein are provided as non-limiting examples.

For example, a name of a user may be processed to omit suffixes, to omit or replace certain characters (e.g., spaces or characters with diacritics), and/or to ensure that each portion of a name is correctly identified as a first, middle, or last name (e.g., accounting for nicknames or commonly shortened names).

As another example, an email address may be processed to omit at least a part of a domain name or to perform partial matching using the email username (e.g., removing leading or trailing numbers/non-alphanumeric characters). Similarly, a phone number may be processed to standardize the number format (e.g., removing a leading +1 or adding hyphens) or to ignore numbers that determined or otherwise defined to be invalid (e.g., having an area code of 777, 800, or 900). As a further example, the phone number may be verified using customer relationship management (CRM) software, based on caller identification data, or may using any of a variety of additional or alternative sources, such that if a name associated with a phone number does not match the name included as part of the identification number, the number may not be included in the graph datastore.

With respect to a user's address, the address may be standardized, evaluated to confirm that it is not an undeliverable address, and, if it is determined that the address is a multiple delivery address (e.g., having multiple suites, units, or apartments), validated to confirm that the address includes a suite, unit, or apartment number, among other examples. For example, a shipping provider may be used to validate a mailing address according to aspects described herein. If the address cannot be validated, it may be omitted from inclusion in the graph datastore.

While example preprocessing techniques are described for various types of identification information, it will be appreciated that any of a variety of additional or alternative techniques may be used for any of a variety of similar or different identification information.

As noted above, a graph subpart associated with a user identifier may be identified from a graph datastore, for example by performing a graph traversal operation. As an example, the graph datastore may be traversed based on an account number, first name, last name, email address, phone number, and/or mailing address, among other identification information (e.g., which were preprocessed or standardized as described above). In examples, one or more derivations of the identification information may additionally or alternatively be used, which may include a combination of identification information and/or various subparts of the identification information (e.g., a beginning part of an email address or a trailing part of a phone number). Accordingly, the use of such derivations may help reduce false positives, thereby decreasing the likelihood that two different user identifiers are inadvertently associated. As noted above, certain identification information may be omitted when traversing the graph datastore, as may be the case when a mailing address could not be validated.

As noted above, a machine learning model may be used to process a feature vector that was generated based on a graph subpart so as to generate model output indicating a set of reputation metrics for a user. A feature vector generated from a graph datastore according to aspects of the present disclosure may include any of a variety of information and/or may include one or more processing results associated with information from the graph datastore accordingly. For example, a graph subpart may be identified, including a user identifier node, associated edges, and other associated nodes. Thus, the graph subpart may include one or more user identifier nodes, associated transaction nodes, and edges connecting the identified nodes.

A feature vector generated based on the graph subpart may include account information associated with one or more accounts nodes and/or transaction information associated with transaction nodes from the graph datastore (e.g., a first date seen, a last date used, a set of transaction dates, and/or a set of transaction amounts), as well as an indication of a number of users associated with a given user identifier. For example, the number of associated users may be determined based on edges between the associated user identifier node and one or more transaction nodes in the graph datastore, which may be evaluated to determine whether an associated first name, middle name, and/or last name is similar or the same for each identified edge. It will be appreciated that additional or alternative identification information may similarly be used for such a determination. The feature vector may include identification information obtained from one or more associated edges, as well as a determination as to a number of days since the user identifier experienced a returned transaction. A feature vector may be generated based on information within a predetermined time period, such as a trailing year or seven years, among other examples.

Aspects of feature vector generation may be parallelized, for example when multiple transaction nodes and associated edges are processed. In other examples, aspects of feature vector generation may be interdependent, such that they are performed serially. In examples, the information with which a feature vector is generated may be user-configurable or otherwise customizable, such that different information may be used to generate a different feature vector depending a requestor of the evaluation. Similarly, a different machine learning model may be used to evaluate such different feature vectors, as a machine learning model may be trained according to a specific set of criteria. As an example, the set of criteria may be represented as a set of rules that are evaluated to extract information from the graph dataset and generate feature vectors accordingly. While example information and feature vector generation techniques are described, it will be appreciated that any of a variety of other information and/or generation techniques may be used in other examples.

An example list of behaviors that may be identified based on a graph datastore and used to generate a feature vector is provided below:

Features that May be End-User Facing:
A stability index model generated according to aspects described herein; in some instances a stability index may further be segmented based one or more sub-attributes, such as age, geographic location, or the existence of multiple identities
Name matching (e.g., indicating account or device ownership); a stronger and/or consistent name match may indicate a higher likelihood of acceptability
Multiple identities flag (e.g., indicating ownership and/or potential fraud); acceptability may be negatively correlated with a number of associated users
Days since account opened or days since a device was last seen, and/or has this account/user/device existed in the past (e.g., based on associated historical activity); a greater amount of time may indicate a higher likelihood of acceptability
Count of accounts (e.g., based on associated historical activity)
Has there ever been any returns on the account (e.g., indicating an associated risk); the existence of or a greater number of returns or other negative historical activity may indicate a lower likelihood of acceptability
Days since acct was last seen (e.g., indicating an associated risk)
Has the device ever been associated with fraud or ever been banned (e.g., indicating an associated risk)
   Features that May be Used for Backend Processing:
A count of emails, phone numbers, addresses, and/or names
Whether there have ever been positive activities, days since a positive activities, a count of positive payments, and/or an amount of positive payments
Whether there have ever been low-risk activities, days since a low-risk activity, a count of low-risk activities, and/or an amount of low-risk activities
Whether there have ever been high-risk activities, days since a high-risk activity, a count of high-risk activities, and/or an amount of high-risk activities

It will be appreciated that, since a feature vector is generated based on a graph subpart of a graph datastore, changes to the graph datastore may result in changes to a subsequently generated feature vector and a resulting model output when the feature vector is processed using a machine learning model according to aspects described herein. Thus, as new historical activity and/or new user identifiers are identified, among other graph updates, a subsequent evaluation request may be processed in view of the updated state of the graph datastore and may thus yield an appropriately updated set of reputation metrics accordingly. Further, it will be appreciated that an update to the graph datastore associated with a first user may have an effect on a set of reputation metrics associated with a second user, as may be the case when the first user is determined to have an association with an account that was already previously associated with the second user.

As noted above, a model processing result (e.g., that was generated as a result of processing a feature vector using a machine learning model according to aspects described herein) may include one or more reputation metrics.

Similar to feature generation, aspects of reputation metric generation may be user-configurable, such that different requestors may receive a different set of reputation metrics, reputation metrics indicating different information, or reputation metrics that are generated according to different scales, among other examples. For example, such differences may stem from different training graph datasets that are used to train associated machine learning models (e.g., having different annotations and/or feature vectors) or may result from adaptation rules that are applied to a model processing result prior to providing the generated set of reputation metrics. As an example, a requestor may only consider users having a stability metric that is six or greater, such that the scale from 6-10 may be remapped to stretch from 1-10 (e.g., such that a six is mapped to a one and an eight is mapped to a five), thereby providing increased granularity for determinations made by the requestor.

Additional reputation metrics include, but are not limited to, an age metric that indicates an age associated with a set of user identifiers (e.g., average age, maximum age, and/or minimum age), a returns metric that indicates a number of days since a user identifier experienced a returned transaction, a transaction metric that indicates a user's usage behavior for one or more associated user identifiers, a risk metric that indicates a risk and/or a pattern of consistency for the user, an ownership metric that indicates whether one or more of the user's accounts are associated solely with the user or are instead associated with a plurality of users, and/or a validity metric that indicates whether one or more of the user's accounts are valid (e.g., according to a set of rules), among other examples. As an example, an account may be determined to be valid if the account is not a Federal Reserve account, if the routing number is determined to be real (e.g., the routing number matches an existing bank or other entity), and/or if an associated account structure matches the indicated institution.

It will be appreciated that such metrics may enable a more thorough, granular, or wholistic evaluation of a user's reputation (potentially with respect to a plurality of user identifiers), as compared to merely evaluating a single user identifier or account information (e.g., a balance and/or transaction history) provided by a user. Further, a set of reputation metrics may include any of a variety of additional or alternative metrics generated based on information of a graph datastore according to aspects described herein. In other examples, information within the graph datastore may be invalidated, omitted, or otherwise ignored when generating a feature vector to evaluate a user according to aspects described herein. For example, an email address, mailing address, and/or phone number associated with a user that is older than a predetermined threshold may be omitted, thereby accounting for gradual changes to a user's identification information.

Thus, it will be appreciated that the disclosed aspects may be applicable in a variety of contexts, each having one or more associated types of historical activity. Example historical activity includes, but is not limited to, a transaction for a monetary resource, a physical resource, or a service, as well as a transaction for a resource of a computing environment (e.g., such as data or processor time). For example, a transaction may be an electronic fund transfer, may be a transfer between addresses on a blockchain, or may include one or more user interactions associated with a social media platform (e.g., user interactions and/or browsing history).

Accordingly, a set of reputation metrics may be generated for a user according to aspects described herein when determining whether to extend credit to the user, whether to permit the user to open or create an additional user identifier, and/or whether to permit the user to generate a payment request. As another example, a set of reputation metrics may be generated in an ecommerce, payments processing, insurance, or rental housing context, for example as an alternative to or in addition to performing a credit check. Similar techniques may be used to evaluate a reputation of a user with respect to a social media platform, for example to determine whether a user identifier is likely to be an automated user (e.g., a bot) or a human user, or whether a first user identifier is associated with a second user identifier for the purpose of ban evasion detection, among other examples. Thus, it will be appreciated that aspects of the present disclosure may be used to evaluate whether an individual and one or more associated user identifiers and/or devices are generally acceptable (e.g., as compared to a set of criteria) based on a given feature space.

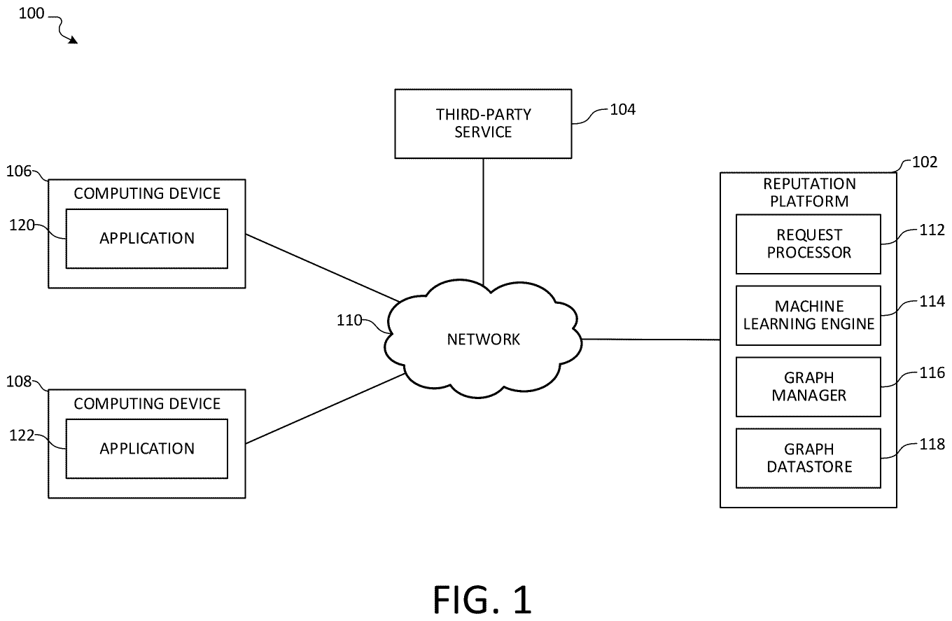

FIG. 1 illustrates an overview of an example system 100 for machine learning-based graph analytics for user evaluation. As illustrated, system 100 comprises reputation platform 102, third-party service 104, computing device 106, computing device 108, and network 110. In examples, reputation platform 102, third-party service 104, computing device 106, and/or computing device 108 communicate via network 110. For example, network 110 may comprise a local area network, a wireless network, or the Internet, or any combination thereof, among other examples.

As illustrated, reputation platform 102 includes request processor 112, machine learning engine 114, graph manager 116, and graph datastore 118. Request processor 112 may process reputation requests to generate a set of reputation metrics for a given user and/or user identifier, as may be received from third-party service 104. While system 100 is illustrated as an example where reputation requests are received from third-party service 104, it will be appreciated that similar techniques may be used to generate a set of reputation metrics local to a computing device at which they will subsequently be processed to make a determination associated with a user, as may be the case if third-party service 104 incorporated aspects of reputation platform 102.

In examples, request processor 112 exposes an application programming interface (API), which may be used to provide reputation requests and receive reputation metrics according to aspects described herein. For example, a reputation request may be received via the API that includes a name, a phone number, an email address, and/or a mailing address, and a set of reputation metrics may be provided in response. In some examples, operation of reputation platform 102 may be configured via the API or via a website of reputation platform 102, among other examples. For example, reputation platform 102 may be configured to control which reputation metrics are generated, manage a set of adaptation rules that are applied to the reputation metrics, provide training data and/or feedback for a machine learning model (e.g., as may be managed by machine learning engine 114), and/or control aspects of feature vector generation, among other examples. In a further application, the API may be used to configure an alert or periodic reporting, such that reputation platform 102 may generate an alert when a change associated with a user is identified (e.g., with respect to a graph subpart for the user or with respect to one or more reputation metrics) or may periodically generate an updated set of reputation metrics.

Machine learning engine 114 may manage one or more machine learning models according to aspects described herein. For example, machine learning engine 114 may train a machine learning model, may generate a feature vector to be processed by a trained machine learning model, and/or may update a machine learning model according to feedback associated with generated model output, among other examples. As noted above, machine learning engine 114 may manage multiple machine learning models, which may each be associated with a different feature vector generation technique and/or requestor (e.g., third-party service 104 or another third-party service, not pictured).

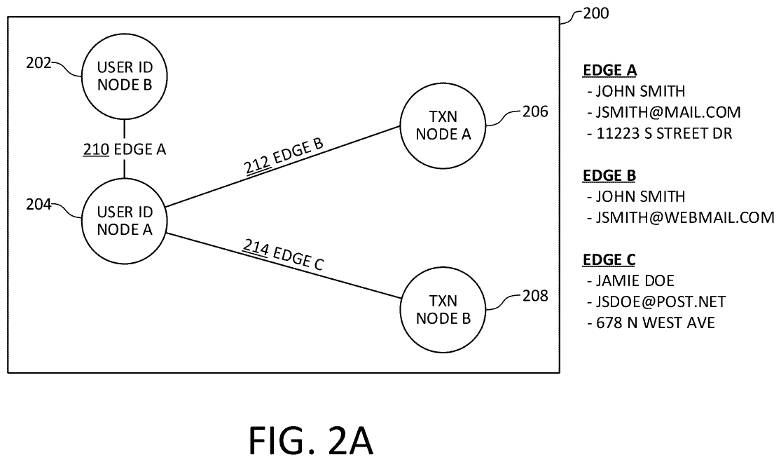

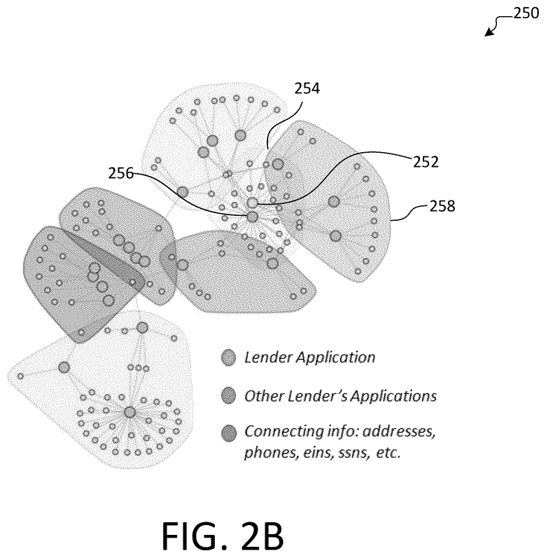

Graph manager 116 manages the content of graph datastore 118 according to aspects described herein. Example content of graph datastore 118 and additional associated aspects are discussed below with respect to FIGS. 2A and 2B. For example, graph manager 116 may generate a new node within graph datastore 118, such as a new user identifier node when a new user identifier is identified or a new transaction node when a new transaction is identified (e.g., as a result of user interactions with computing device 106 or computing device 108). Similarly, graph manager 116 may generate new edges within graph datastore 118 and/or may perform data preprocessing prior to adding data to graph datastore 118 and when determining whether existing nodes and/or edges of graph datastore 118 match provided identification information. Thus, graph manager 116 may identify any of a variety of events (e.g., account creation, account closure, payment requests, successful transactions, and/or returned transactions, among other examples) and perform subsequent processing so as to maintain the information of graph datastore 118 and ensure that resulting reputation metrics are up-to-date and representative of a user's reputation.

Third-party service 104 may comprise one or more computing devices associated with any of a variety of services, including, but not limited to, financial institutions, social networking services, ecommerce platforms, insurance providers, and/or property management companies. While system 100 is illustrated as including a single third-party service 104, it will be appreciated that any number of third-party services may be used in other examples. In examples, a third-party service, such as third-party service 104, may provide an indication of an event, which may be processed by graph manager 116 to update graph datastore 118 accordingly.

System 100 is further illustrated as comprising computing device 106 and computing device 108, which each include application 120 and application 122, respectively. Aspects of computing device 108 and application 122 are similar to computing device 106 and application 120 and are therefore not necessarily re-described below in detail. With reference to computing device 106, computing device 106 may be any of a variety of computing devices, including, but not limited to, a mobile computing device, a tablet computing device, a laptop computing device, or a desktop computing device. A user may use application 120 to access a website or otherwise interact with a variety of service or platforms via network 110 (e.g., associated with third-party service 104 and/or reputation platform 102). In examples, user interactions via application 120 may be associated with events that are processed by graph manager 116 as described above. For example, a transaction may be initiated or a user may open a new account using application 120, among other examples. It will be appreciated that any number of computing devices may be used in other examples.

As another example, computing device 106 or computing device 108 may be used to request a set of reputation metrics are generated and/or view a set of reputation metrics that was generated by reputation platform 102. For instance, application 120 and/or 122 may be used to access a website associated with reputation platform 102. Similarly, aspects of reputation platform 102 may be configured as described above. Thus, it will be appreciated that functionality of reputation platform 102 may be made accessible via an API and/or a website, among other examples.

FIGS. 2A and 2B illustrate overviews of example graphs with which aspects of the present disclosure may be performed. For example, the illustrated graphs may be stored within a graph datastore, such as graph datastore 118 discussed above with respect to FIG. 1. The graphs may be generated or otherwise maintained by a graph manager, such as graph manager 116, according to aspects described herein.

With reference to graph 200 of FIG. 2A, user identifier nodes 202 and 204 are illustrated in combination with transaction nodes 206 and 208. Each node of nodes 202, 204, 206, and 208 may have a set of associated properties. For example, user identifier nodes 202 and 204 may have associated user identifier information, while transaction nodes 206 and 208 may have associated transaction information. As illustrated, user identifier nodes 202 and 204 are associated by edge A 210, which has associated identification information (e.g., indicating both user identifier A and user identifier B are associated with John Smith).

Similarly, user identifier node A 204 is associated with transaction nodes 206 and 208 by edges 212 and 214, respectively. While edge B 212 similarly includes identification information indicating an association with John Smith, edge C 214 to transaction node B 208 indicates a transaction associated with user identifier node A 204 having associated identification information for Jamie Doe. Thus, when generating a set of reputation metrics for either John Smith or Jamie Doe, a graph subpart including nodes 204, 206, and 208 would be processed and would further determine that user identifier node 204 is associated with multiple users.

FIG. 2B depicts an overview of example graph 250, in which various nodes and associated edges are categorized into various graph subparts using associated color coding. It will be appreciated that the color coding is provided for illustrative purposes. For example, graph subpart 254 may be associated with a first user, while graph subpart 258 is associated with a second, but related (e.g., by virtue of various intermediate nodes), user. In other examples, graph subparts 254 and 258 may each be associated with the same user. Thus, various graph subparts are associated as a result of having the same or similar associated identification information.

In examples, a traversal according to aspects described herein may associate a user identifier (e.g., a request to create a new user identifier, as indicated by user identifier node 252) with one or more bank transactions (e.g., thereby indicating historical activity). In some instances, a transaction in that history and/or one or more other user identifiers may not have been previously identified in association with the given user identifier, such that a graph datastore traversal may be performed to determine such associations accordingly. Thus, as illustrated by graph 250, one or more graph subparts (e.g., graph subpart 254, including user identifier node 256 and associated transactions) may be identified as a result of a traversal performed based on user identifier node 252 according to aspects of the present disclosure.

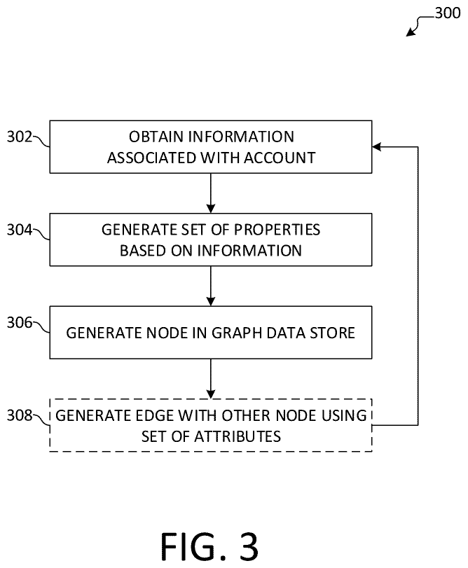

FIG. 3 illustrates an overview of an example method 300 for maintaining a graph datastore according to aspects of the present disclosure. In examples, aspects of method 300 are performed by a graph manager, such as graph manager 116 discussed above with respect to FIG. 1.

Method 300 begins at operation 302, where information associated with a user identifier is obtained. For example, the information may be obtained from a third-party service, such as third-party service 104 in FIG. 1. In other examples, operation 302 comprises polling a data source of updated information. It will thus be appreciated that any of a variety of techniques may be used to obtain such information at operation 302. The information may include user identifier information and/or transaction information, as may be the case when a new user identifier is created or there is a new transaction associated with a user identifier, respectively.

Flow progresses to operation 304, where a set of properties is generated based on the obtained information. In examples, operation 304 comprises preprocessing the information as described above, thereby increasing the likelihood that the information will be associated with pre-existing related information within the graph datastore. In examples, operation 304 generates a set of properties that will be associated with a user identifier and/or transaction node and a set of properties that will be associated with an edge within the datastore.

Moving to operation 306, a node is generated within the graph datastore. In instances where the obtained information includes transaction information, operation 306 comprises generating a new transaction node within the graph datastore. The set of properties that was generated at operation 304 may be associated with the new transaction node. Similarly, if the obtained information includes user identifier information, operation 306 includes generating a new user identifier node within the graph datastore. Operation 306 may comprise determining whether a user identifier node already exists within the graph datastore, such that a new user identifier node need not be generated in instances where a user identifier node is preexisting. By contrast, if a transaction node is generated and a user identifier node is not present in the graph datastore, operation 306 may further comprise generating the user identifier node accordingly.

At operation 308, an edge is generated to associate a node that was generated at operation 306 with another node within the graph dataset. For example, if two nodes were generated at operation 306, an edge may be generated to associated both of the generated nodes. As another example, if a user identifier node was preexisting and a transaction node was generated at operation 306, a node may be generated between the preexisting user identifier node and the new transaction node. Such edges may be similar to edges 212 and 214 discussed above with respect to FIG. 2A. As a further example, if a user identifier node was generated at operation 306 and another user identifier node is present within the graph dataset that is associated with the same user, an edge may be generated between the two user identifier nodes (e.g., similar to edge A 210 discussed above with respect to FIG. 2A). Operation 308 is illustrated using a dashed box to indicate that, in some examples, operation 308 may be omitted. For example, if only a user identifier node is generated at operation 306 and another preexisting user identifier node does not exist within the graph datastore, operation 308 may be omitted. Method 300 terminates at operation 308.

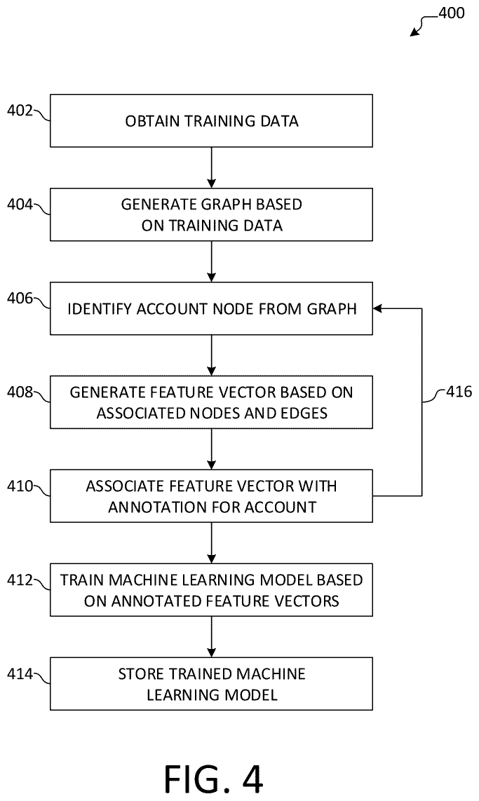

FIG. 4 illustrates an overview of an example method 400 for training a machine learning model for user evaluation. In examples, aspects of method 400 are performed by a reputation platform, such as reputation platform 102 discussed above with respect to FIG. 1. For example, machine learning engine 114 may perform at least a part of method 400.

Method 400 begins at operation 402, where training data is obtained. For example, the training data may be historical activity and associated user identifiers or may be synthetic training data that was generated to provide examples of both normal and abnormal user identifiers. It will thus be appreciated that the training data may be obtained from any of a variety of sources.

At operation 404, a graph is generated based on the training data. Aspects of operation 404 may be similar to those discussed above, for example with respect to method 300 of FIG. 3, and are therefore not redescribed in detail. The resulting graph may include one or more user identifier nodes and/or transaction nodes, as well as associated edges. The graph may include normal and abnormal graph subparts associated with various users.

Flow progresses to operation 406, where a user identifier node is identified from a graph. The user identifier may be randomly identified or may be identified based on an annotation associated with the user identifier, among other examples. At operation 408, a feature vector is generated based on nodes and edges associated with the identified user identifier node. As noted above, the graph subpart including the node that was identified at operation 406 may be processed to generate a feature vector that encodes a variety of information and/or processing results associated with the graph subpart. The feature vector generation technique applied at operation 408 may be user-configurable and may thus vary depending on the requestor and/or the machine learning model that is being trained according to method 400.

Moving to operation 410, the generated feature vector is associated with an annotation for the user identifier, for example to indicate that the feature vector is indicative of a normal user identifier or an abnormal user identifier, among other examples. Method 400 is illustrated as including arrow 416 from operation 410 to operation 406 to indicate that flow may loop between operations 406, 408, and 410 to generate annotated feature vectors with which to train a machine learning model.

Eventually, flow progresses to operation 412, where the machine learning model is trained using the annotated feature vectors. It will be appreciated that any of a variety of techniques may be used to train the machine learning model accordingly. At operation 414, the trained machine learning model is stored (e.g., by a reputation platform, such as reputation platform 102 in FIG. 1). In examples, the trained machine learning model may be additionally or alternatively provided to a third-party service (e.g., third-party service 104) or any of a variety of other computing devices, as may be the case when reputation processing is performed locally (e.g., or otherwise remote from a reputation platform). Method 400 terminates at operation 414.

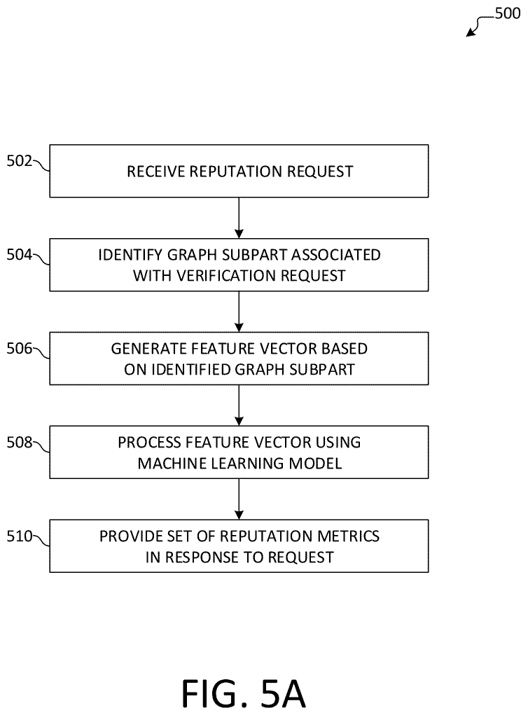

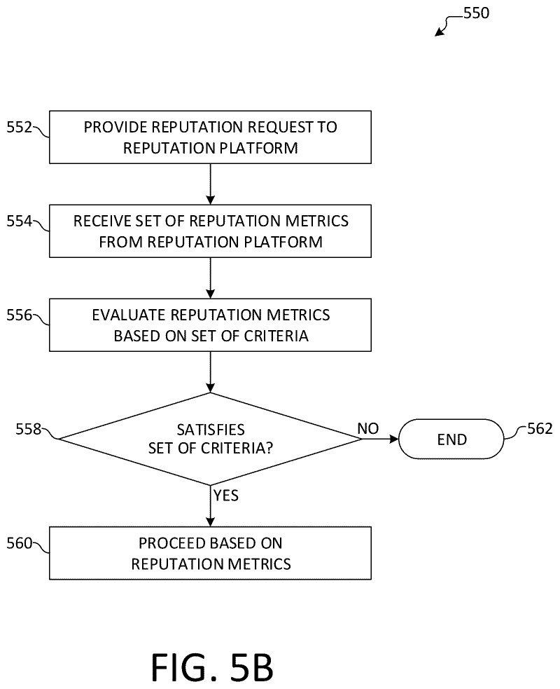

FIG. 5A illustrates an overview of an example method 500 for processing a reputation request by a verification platform. In examples, aspects of method 500 may be performed by a reputation platform, such as reputation platform 102 discussed above with respect to FIG. 1.

Method 500 begins at operation 502, where a reputation request is received. For example, the request may be received from a third-party service (e.g., third-party service 104 in FIG. 1) or from a computing device (e.g., computing device 106 or 108), among other examples. The request may include identification information associated with a user and/or an indication of a user identifier for which a set of reputation metrics is being requested. The reputation request may be received by a request processor, such as request processor 112 in FIG. 1.

At operation 504, a graph subpart associated with the verification request is identified. In examples, operation 504 comprises preprocessing at least a part of the information that was received as part of the reputation request. Such aspects may be similar to aspects discussed above with respect to operation 304 of method 300 and are therefore not necessarily redescribed. The graph subpart may be identified within a graph datastore (e.g., graph datastore 118) based at least in part on identifying one or more edges having identification information that matches identification information provided as part of the reputation request. A match may be an exact match or an inexact match (e.g., using partial matching or fuzzy matching), among other examples. The identified graph subpart may include one or more user identifier nodes, transaction nodes, and/or associated edges.

Flow progresses to operation 506, where a feature vector is generated based on the identified graph subpart. As described above, the generated feature vector may include information from the identified graph subpart and/or processing results generated based at least in part on such information, among other examples. Such aspects are similar to those described above (e.g., with respect to operation 408 of method 400) and are therefore not necessarily redescribed.

Moving to operation 508, the feature vector is processed using a machine learning model that was trained according to aspects of the present disclosure. For example, the machine learning model may have been trained according to method 400 discussed above with respect to FIG. 4. A machine learning engine (e.g., machine learning engine 114) may process the feature vector using the machine learning model to generate a set of reputation metrics.

At operation 510, the set of reputation metrics is provided in response to the reputation request that was received at operation 502. In examples, at least some of the reputation metrics that are provided may be generated separate (but, in some examples, based at least in part on) from the application of the machine learning model at operation 508. For example, a reputation metric may be generated based on the content of the graph subpart that was identified at operation 504 as discussed above. Method 500 terminates at operation 510.

FIG. 5B illustrates an overview of an example method 550 for evaluating a user according to a set of reputation metrics obtained from a verification platform. In examples, aspects of method 550 may be performed by a third-party service, such as third-party service 104 discussed above with respect to FIG. 1.

Method 550 begins at operation 552, where a reputation request is provided to a reputation platform, such as reputation platform 102. As noted above, the reputation request may include identification information associated with a user and/or an indication of a user identifier for which a set of reputation metrics is being requested. While methods 500 and 550 are described in an example where a client issues a reputation request, a server processes the reputation request, and a client makes a determination based on the resulting set of reputation metrics, it will be appreciated that similar aspects may be performed by a single device.

At operation 554, a set of reputation metrics is received from the reputation platform. For example, the reputation metrics may be received using an API of the reputation platform, among other examples. Flow progresses to operation 556, where the set of reputation metrics is evaluated based on a set of criteria. Example criteria include, but are not limited to, a minimum stability metric (e.g., greater than or equal to six), that an ownership metric indicates that a user is the sole user associated with a given user identifier, that a returns metric indicate that a user has not had a returned transaction with a predetermined time period, and/or that an age metric indicates a user identifier history above a predetermined threshold. It will be appreciated that any of a variety of additional or alternative criteria may be used in other examples.

At determination 558, it is determined whether the set of reputation metrics satisfies the set of criteria. If it is determined that the set of metrics fails to satisfy the criteria, flow branches “NO” and terminates at operation 562. In some examples, an indication as to why the evaluation failed may be provided (e.g., to a user device of a user for which the reputation evaluation was performed and/or via an electronic communication to an email address associated with the user).

By contrast, if it is determined that the set of metrics satisfies the set of criteria, flow instead branches “YES” to operation 560, where processing proceeds based on the set of reputation metrics. For example, access may be granted to one or more resources and/or services. As another example, the user may be permitted to create a new user identifier. It will thus be appreciated that a set of reputation metrics generated according to aspects described herein may be used to determine whether to perform any of a variety of actions accordingly. Method 550 terminates at operation 560.

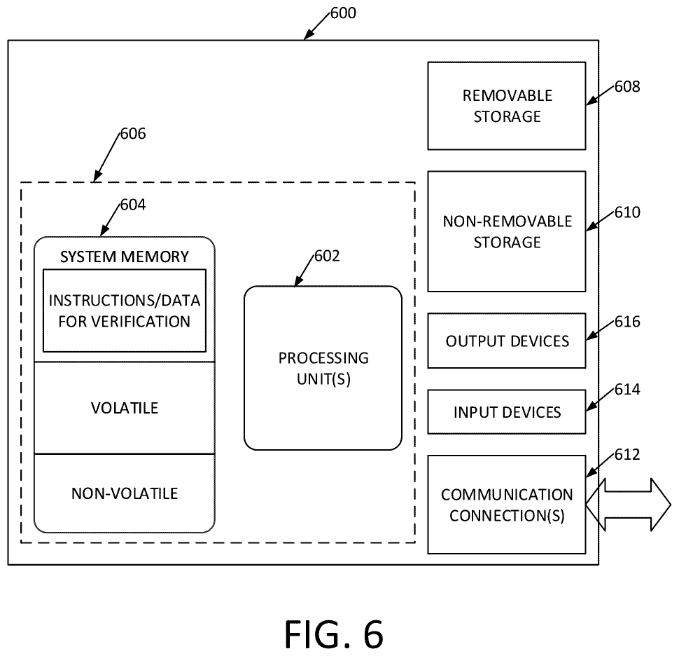

FIG. 6 illustrates an example of a suitable operating environment 600 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 600 typically may include at least one processing unit 602 and memory 604. Depending on the exact configuration and type of computing device, memory 604 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as a keyboard, mouse, pen, voice input, etc. and/or output device(s) 616 such as a display, speakers, printer, etc. Also included in the environment may be one or more communication connections, 612, such as LAN, WAN, point to point, etc.

Operating environment 600 may include at least some form of computer readable media. The computer readable media may be any available media that can be accessed by processing unit 602 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 604. While executing on the processing unit 602, program modules (e.g., applications, Input/Output (I/O) management, and other utilities) may perform processes including, but not limited to, one or more of the stages of the operational methods described herein such as the methods illustrated in FIG. 3, 4, 5A, or 5B, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 600 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
identifying, from a graph datastore, a graph subpart associated with a user identifier;
generating, based on the identified graph subpart, a feature vector;
processing, using a machine learning model, the feature vector to generate a set of reputation metrics; and
providing an indication of the generated set of reputation metrics to a third-party service.

2. The system of claim 1, wherein the machine learning model is trained based on a set of annotated feature vectors generated from a training graph datastore, wherein the training graph datastore includes a normal graph subpart and an abnormal graph subpart.

3. The system of claim 1, wherein the identified graph subpart includes at least one user identifier node, at least one transaction node, and an edge node associating a user identifier node and a transaction node.

4. The system of claim 3, wherein the edge node is associated with a property that includes identification information for a user of the user identifier.

5. The system of claim 1, wherein the user identifier is a first user identifier associated with a user and the identified graph subpart includes a first node for the first user identifier and a second node for a second user identifier that is also associated with the user.

6. The system of claim 1, wherein the set of reputation metrics comprises at least one of:
a stability metric for the user identifier; or
a supplemental information for the user identifier.

7. The system of claim 1, wherein the indication of the generated set of reputation metrics is provided in response to a request from the third-party service.

8. A method for maintaining a graph datastore, comprising:
obtaining transaction information associated with a user identifier;
preprocessing identification information of the transaction information;
generating, within the graph datastore, a transaction node including a set of properties based on the transaction information; and
generating an edge between the generated transaction node and a user identifier node for the user identifier, wherein the edge includes at least a part of the preprocessed identification information.

9. The method of claim 8, further comprising:
determining whether the graph datastore includes the user identifier node for the user identifier; and
based on determining the graph datastore does not include the user identifier node, generating the user identifier node for the user identifier.

10. The method of claim 8, wherein preprocessing the identification information comprises one or more of:
processing a name of the identification information to omit a suffix, to omit a character, or to replace a character;
processing an email address of the identification information to omit a domain name of the email address or to perform partial matching using a part of the email address;
processing a phone number of the identification information to omit a part of the phone number or to determine whether to omit the phone number for inclusion in the graph datastore when the phone number is invalid; or
processing a mailing address of the identification information to determine whether to omit the mailing address for inclusion in the graph datastore when a shipping provider indicates the mailing address is invalid.

11. The method of claim 8, wherein the user identifier node is further associated with another transaction node by another edge within the graph datastore, and the another edge includes identification information for a user different than a user associated with the user identifier.

12. The method of claim 8, further comprising:
receiving, from a third-party service, a request for a set of reputation metrics associated with a given user identifier;
identifying, from the graph datastore, a graph subpart associated with the given user identifier;
generating, based on the identified graph subpart, a feature vector;
processing, using a machine learning model, the feature vector to generate the set of reputation metrics; and
providing, to the third-party service, an indication of the generated set of reputation metrics.

13. The method of claim 12, wherein the machine learning model is trained based on a set of annotated feature vectors generated from a training graph datastore, wherein the training graph datastore includes a normal graph subpart and an abnormal graph subpart.

14. A method, comprising:
identifying, from a graph datastore, a graph subpart associated with a user identifier;
generating, based on the identified graph subpart, a feature vector;
processing, using a machine learning model, the feature vector to generate a set of reputation metrics; and
providing an indication of the generated set of reputation metrics to a third-party service.

15. The method of claim 14, wherein the machine learning model is trained based on a set of annotated feature vectors generated from a training graph datastore, wherein the training graph datastore includes a normal graph subpart and an abnormal graph subpart.

16. The method of claim 14, wherein the identified graph subpart includes at least one user identifier node, at least one transaction node, and an edge node associating a user identifier node and a transaction node.

17. The method of claim 16, wherein the edge node is associated with a property that includes identification information for a user of the user identifier.

18. The method of claim 14, wherein the user identifier is a first user identifier associated with a user and the identified graph subpart includes a first node for the first user identifier and a second node for a second user identifier that is also associated with the user.

19. The method of claim 14, wherein the set of reputation metrics comprises at least one of:
a stability metric for the user identifier; or
a supplemental information for the user identifier.

20. The method of claim 14, wherein the indication of the generated set of reputation metrics is provided in response to a request from the third-party service.
